(19) United States
(12) Patent Application Publication
(10) Pub. No.: US 2023/0347820 A1
(43) Pub. Date: Nov. 2, 2023

(54) UNMANNED VEHICLE, INFORMATION PROCESSING METHOD, AND INFORMATION PROCESSING SYSTEM

(71) Applicant: Rakuten Group, Inc., Tokyo (JP)

(72) Inventor: Toshiaki TAZUME, Tokyo (JP)

(73) Assignee: Rakuten Group, Inc., Tokyo (JP)

(21) Appl. No.: 18/306,355

(22) Filed: Apr. 25, 2023

(30) Foreign Application Priority Data
Apr. 28, 2022 (JP) 2022-074570

(51) Int. Cl. B60Q 5/00; B60W 60/00

(52) U.S. Cl. CPC B60Q 5/006; B60W 60/00256; B60W 2554/4029; B60W 2554/4041

(57) ABSTRACT

An unmanned vehicle is configured to execute an acquisition process that acquires sound identification information selected by one or more other unmanned vehicles located nearby. The sound identification information is included in multiple types of sound identification information each associated with a sound that has a different characteristic. The unmanned vehicle is further configured to execute a sound selection process that refers to the acquired sound identification information to select sound identification information that is different from the sound identification information selected by at least one of the other unmanned vehicles and an output control process that outputs a sound having a characteristic corresponding to the selected sound identification information.

### BACKGROUND

### 1. Field

The present disclosure relates to an unmanned vehicle, an information processing method, and an information processing system.

### 2. Description of Related Art

Information processing systems that cause an unmanned vehicle to deliver a package to a user have been in practical use. PCT Publication No. 2018/216502 discloses an example of an information processing system that includes an unmanned vehicle (cart) that travels between points at which a package is to be received. The unmanned ground vehicle outputs a sound (e.g., alert or beep) from a speaker depending on the situation. An alert is output, for example, when the situation is risky, when the vehicle turns, when the vehicle stops, when the vehicle starts traveling, or when an emergency occurs. A beep is output when, for example, an item is left in a box of the unmanned ground vehicle.

When multiple unmanned ground vehicles each deliver a package in the same delivery area, these unmanned ground vehicles may be present at an intersection or a delivery place. In such a situation, when the unmanned ground vehicles each output a sound, the sounds may overlap each other. In this case, it is difficult for a person located near the unmanned ground vehicles to identify the unmanned ground vehicle that outputs a sound to that user. Thus, the user may have trouble handling the unmanned ground vehicle.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

An unmanned vehicle according to an aspect is configured to execute an acquisition process that acquires sound identification information selected by one or more other unmanned vehicles located nearby. The sound identification information is included in multiple types of sound identification information each associated with a sound that has a different characteristic. The unmanned vehicle is further configured to execute a sound selection process that refers to the acquired sound identification information to select sound identification information that is different from the sound identification information selected by at least one of the other unmanned vehicles and an output control process that outputs a sound having a characteristic corresponding to the selected sound identification information.

An information process method according to another aspect is executed by an unmanned vehicle or a controller that controls the unmanned vehicle. The information processing method includes acquiring sound identification information selected by one or more other unmanned vehicles located nearby. The sound identification information is included in multiple types of sound identification information each associated with a sound that has a different characteristic. The information processing method further includes referring to the acquired sound identification information to select sound identification information that is different from the sound identification information selected by at least one of the other unmanned vehicles and outputting a sound having a characteristic corresponding to the selected sound identification information.

An information processing system according to a further aspect includes a server and unmanned vehicles. The unmanned vehicles includes a first unmanned vehicle and one or more second unmanned vehicles. At least one of the server or the first unmanned vehicle is configured to execute a process that acquires sound identification information selected by the one or more second unmanned vehicles located near the first unmanned vehicle. The sound identification information is included in multiple types of sound identification information each associated with a sound that has a different characteristic. At least one of the server or the first unmanned vehicle is further configured to execute a process that refers to the acquired sound identification information to select sound identification information that is different from the sound identification information selected by at least one of the second unmanned vehicles and a process that causes the first unmanned vehicle to output a sound having a characteristic corresponding to the selected sound identification information.

Other features and aspects will be apparent from the following detailed description, the drawings, and the claims.

### BRIEF DESCRIPTION OF DRAWINGS

FIG. 1 is a diagram schematically showing the configuration of a logistics management system according to a first embodiment.

FIG. 2 is a block diagram showing the configuration of the unmanned ground vehicle in the first embodiment.

FIG. 3 is a table schematically showing the delivery plan information in the first embodiment.

FIG. 4 is a table schematically showing the sound attribute information in the first embodiment.

FIG. 5 is a table schematically showing the sound selection information in the first embodiment.

FIG. 6 is a flowchart illustrating a procedure of the sound output process in the first embodiment.

FIG. 7 is a flowchart illustrating a procedure of the sound selection process in the first embodiment.

FIG. 8 is a flowchart illustrating a procedure of the cancellation process in the first embodiment.

FIG. 9 is a diagram showing an example in which unmanned vehicles are located near an intersection.

FIG. 10 is a diagram showing an example in which unmanned vehicles are located near the intersection.

FIG. 11 is a diagram showing an example in which unmanned vehicles are located near the intersection.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

An unmanned vehicle, an information processing device, and an information processing system according to an embodiment will now be described. In this embodiment, the unmanned vehicle is an unmanned ground vehicle (UGV) that travels on a road. Further, the information processing system is a logistics management system 1 that delivers a package using an unmanned ground vehicle.

### Logistics Management System

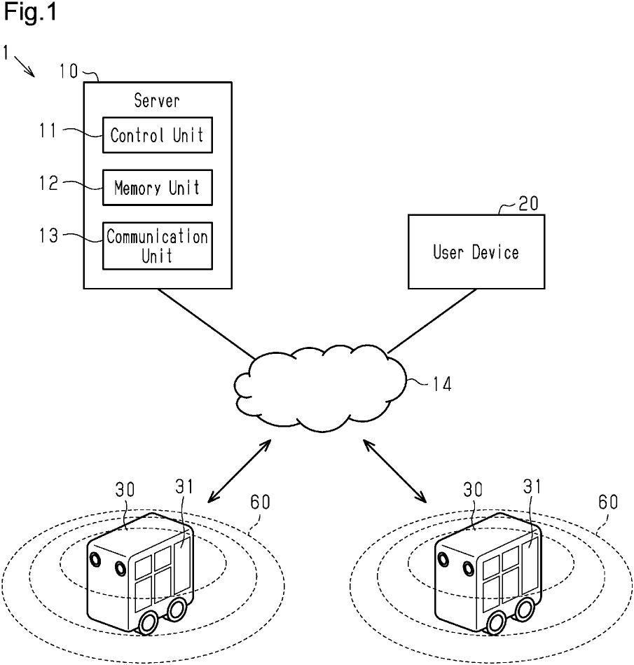

As shown in FIG. 1, the logistics management system 1 includes a server 10 and unmanned ground vehicles 30. The logistics management system 1 is connected to a user device 20 via a network 14.

### Server

The server 10 is managed by a logistics manager or a manager that offers logistics management services. The server 10 includes a control unit 11, a memory unit 12, and a communication unit 13. The control unit 11 includes an arithmetic logic unit and a memory (memory medium). The arithmetic logic unit loads, for example, an operating system and various programs (e.g., logistics management program) into the memory of the control unit 11 from the memory unit 12 or a storage, and executes instructions retrieved from the memory of the control unit 11. The control unit 11 may include the following circuitry.

(1) Circuitry including one or more processors that run according to a computer program (software);
(2) Circuitry including one or more dedicated hardware circuits that execute at least part of various processes; or
(3) Circuitry including a combination thereof.

The control unit 11 includes a CPU and a memory (e.g., RAM and ROM). The memory stores program codes or commands configured to cause the CPU to execute processes. The memory (i.e., computer-readable medium) includes any type of medium that is accessible by general-purpose computers or dedicated computers. Alternatively, instead of or in addition to the CPU, the control unit 11 may include a dedicated hardware circuit (for example, application specific integrated circuit (ASIC)) that executes hardware processing for at least part of the processes executed by the arithmetic logic unit.

The memory unit 12 is an auxiliary storage device (memory medium), and includes various types of information used to manage logistics. The communication unit 13 is implemented as hardware, software, or a combination thereof. The communication unit 13 sends and receives data to and from the user device 20 and an unmanned ground vehicle 30 via the network 14. The server 10 may include an operation part or a display part for which a logistics manager performs an input operation.

### User Device

The user device 20 is an information processing device used by a user who uses the logistics management system 1. The user device 20 is a multi-functional telephone terminal (e.g., smartphone), a tablet terminal, a personal computer, a wearable computer, or another information processing device. The user device 20 has the same hardware configuration as the server 10 and thus has one of the above configurations (1) to (3). The arithmetic logic unit of the user device 20 loads, for example, an operating system and various programs (e.g., a program that executes processes related to receiving a package) into the memory of the user device 20 from a memory unit or a storage, and executes instructions retrieved from that memory. The user device 20 receives a delivery-related notification from the logistics management system 1. The notification includes a notification in a call from the logistics management system 1, a notification in an electronic mail, and a notification in an application stored in the memory unit of the user device 20.

### Unmanned Ground Vehicle

The unmanned ground vehicle 30 is a movable device without a person onboard. The unmanned ground vehicle 30 is managed by a logistics manager or another owner. One unmanned ground vehicle 30 executes vehicle-to-vehicle communication 60 with one or more other unmanned ground vehicles 30 that are located nearby. The unmanned ground vehicle 30 includes a box 31 that accommodates a package that is to be delivered. Each unmanned ground vehicle 30 of FIG. 1 includes multiple boxes 31. In the unmanned ground vehicle 30 stores each box 31, the package, and the user that receives the package are stored in association with each other. In a situation in which the user is receiving the package, the unmanned ground vehicle 30 outputs a sound that assists the receiving of a package (e.g., “Box number 1 will open.”).

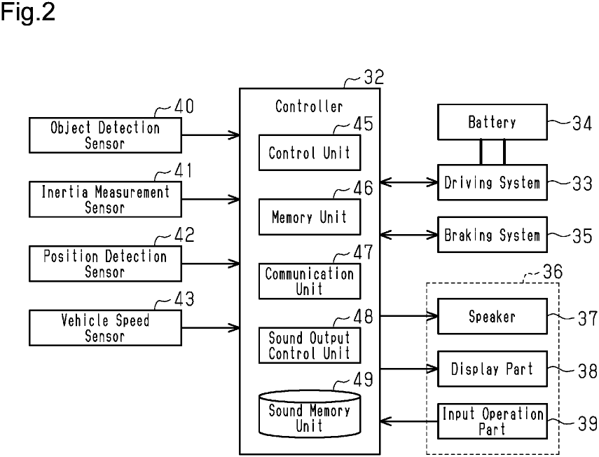

The configuration of the unmanned ground vehicle 30 will now be described with reference to FIG. 2. The unmanned ground vehicle 30 includes a controller 32, a driving system 33, a battery 34, and a braking system 35.

The controller 32 has the same hardware configuration as the server 10 and thus has one of the above configurations (1) to (3).

The driving system 33 includes, for example, a drive source that is driven by electric power supplied from the battery 34, a power transmission mechanism that is operated by the power obtained from the drive source, and a control circuit that controls the drive source. The drive source is, for example, an electric motor. The drive source may be an engine that is driven by consuming fuel. In this case, instead of the battery 34, the unmanned ground vehicle 30 includes a fuel supplying unit that supplies the drive source with fuel. The unmanned ground vehicle 30 may include a hybrid system equipped with various types of drive sources. The power transmission mechanism transmits the power of the drive source to wheels. The unmanned ground vehicle 30 may be able to move not only in the front-rear direction but also in a direction that intersects the front-rear direction. For example, the wheels may be able to rotate not only in a first direction and its opposite direction but also in multiple directions, including a direction that is orthogonal to the first direction. The braking system 35 stops rotation of the wheels based on the signal output from the controller 32. Based on the route plan, the controller 32 outputs a command for motion (e.g., start, left turn, or right turn) to the driving system 33 and outputs a stop command or a deceleration command to the braking system 35.

The unmanned ground vehicle 30 further includes a human machine interface (HMI) 36. The HMI 36 includes a speaker 37.

The HMI 36 may also include a display part 38 and an input operation part 39.

The speaker 37 is implemented as a combination of hardware and software. The speaker 37 outputs a warning sound, an alert, or a sound related to operation guidance for receiving a package.

The display part 38 indicates information related to an operation for receiving the package. The input operation part 39 is, for example, a touch panel to which the user enters an authentication code such as a personal identification number (PIN), an input device including a button, or a scanner that recognizes a barcode or a two-dimensional code presented.

The unmanned ground vehicle 30 further includes an object detection sensor 40, an inertia measurement sensor 41, a position detection sensor 42, and a vehicle speed sensor 43. These sensors each output a detection result to the controller 32. The object detection sensor 40 is configured to detect an object located nearby. For example, the object detection sensor 40 is a capturing device. The capturing device may include an omnidirectional camera that performs capturing in all directions (the entire sphere), the center of which is the unmanned ground vehicle 30, or multiple visible light cameras. Instead, the object detection sensor 40 may be a distance measurement sensor (e.g., a millimeter wave radar or an ultrasonic sensor). Alternatively, the object detection sensor 40 may be an infrared sensor. In one example, the object detection sensor 40 may be a combination of an image sensor and an infrared sensor in which a Lidar sensor is employed. Lidar stands for light detection and ranging or laser imaging, detection, and ranging. The object detection sensor 40 is not limited to the above sensors. The unmanned ground vehicle 30 includes two or more of these sensors in accordance with the intended use.

Examples of the inertia measurement sensor 41 include an acceleration sensor or a gyro sensor. Examples of the position detection sensor 42 include a GPS sensor, a geomagnetic sensor, an altitude sensor, and a displacement sensor. The vehicle speed sensor 43 is disposed on a wheel to detect the speed of the unmanned ground vehicle 30.

The controller 32 will now be described. The controller 32 includes a control unit 45, a memory unit 46, and a communication unit 47. The configuration of the control unit 45 is substantially the same as that of the control unit 11 of the server 10.

The configuration of the memory unit 46 is substantially the same as that of the memory unit 12 of the server 10. The memory unit 46 stores various types of information that is necessary for autonomous traveling. (e.g., an autonomous traveling program and map information) Further, the memory unit 46 stores route plan information and delivery plan information. The route plan information indicates a route plan from a start point (e.g., a warehouse or a store) to an end point via a package delivery place. The delivery plan information associates a package and a user. The route plan information may include identification information (e.g., an intersection and a road). The delivery plan information may include, for example, one or more of the identification information of a package, the delivery place of the package, and the number of a box that accommodates the package.

The communication unit 47 is implemented as hardware, software, or a combination thereof. The communication unit 47 sends and receives data to and from the user device 20 and the server 10 via the network 14. The communication unit 47 is configured to execute wireless communication in conformity with a communication standard of vehicle-to-vehicle communication. The communication data sent and received through vehicle-to-vehicle communication includes vehicle identification data used to identify a vehicle, a vehicle position, and a movement direction (travel direction). The control unit 45 of the unmanned ground vehicle 30 may execute vehicle-to-vehicle communication with another vehicle. In this case, the vehicle identification data included in the vehicle-to-vehicle communication data is used to determine whether there is data sent from the unmanned ground vehicle 30. Alternatively, the control unit 45 may communicate with only the unmanned ground vehicle 30 via the communication unit 47.

The communication unit 47 sends various notifications to the user device 20 via the network 14. The unmanned ground vehicle 30 may send notifications to the user device 20 via the server 10. Alternatively, the unmanned ground vehicle 30 may send notifications to the user device 20 without using the server 10. The unmanned ground vehicle 30 may be connected to a manager terminal (not shown) used by a delivery manager via the network 14. Using the manager terminal, the delivery manager may visually check an image captured by the image sensor of the unmanned ground vehicle 30 to monitor the state of the unmanned ground vehicle 30.

The controller 32 includes a sound output control unit 48 and a sound memory unit 49. The sound output control unit 48 outputs a sound corresponding to a situation from the speaker 37 based on the sound identification information selected by the control unit 45. The sound identification information is allocated to a sound that has a unique characteristic. For example, the sound identification information includes three numbers (e.g., 1 to 3). For example, a different type of the sound identification information is allocated to each of multiple virtual speakers that are set on a system. For example, the sound of a speech given by a particular male person is associated with the sound identification information of 1. The sound of a speech given by a particular female person is associated with the sound identification information of 2. The sound of a speech given by a different female person is associated with the sound identification information of 3. That is, the sound based on data associated with the sound identification information of 1 to 3 can be recognized as a speech given by a person who speaks in everyday life as the user identifies the voice of that person as a voice specific to that person. For example, one or more characteristics of a sound include the distribution of frequencies (e.g., a formant), a basic frequency (e.g., a pitch), or a frequency having the largest strength. The characteristics of a sound may also include a speaking speed or an intonation.

The sound output control unit 48 outputs, for example, a sound that alerts a person located nearby to the traveling of the unmanned ground vehicle 30 and a sound that guides an operation for receiving a package or produces an alert. When an event that causes a sound to be output (hereinafter referred to as a sound output event) occurs, the sound output control unit 48 selects sound data suitable for the sound output event from the sound data stored in the sound memory unit 49. Then, the sound output control unit 48 uses waveform data included in the selected sound data to output the sound from the speaker 37. The waveform data corresponds to output control data that is used to output a sound from the speaker 37.

The sound memory unit 49 stores multiple types of sound data. The multiple types of sound data include waveform data that differs between multiple types of the sound identification information. For example, the sound data includes waveform data used to output a sound having content that differs depending on each sound output event. The control unit 45 and the sound output control unit 48 may be integrated into an apparatus. The sound memory unit 49 and the memory unit 46 may be integrated into an apparatus.

### Data Configuration

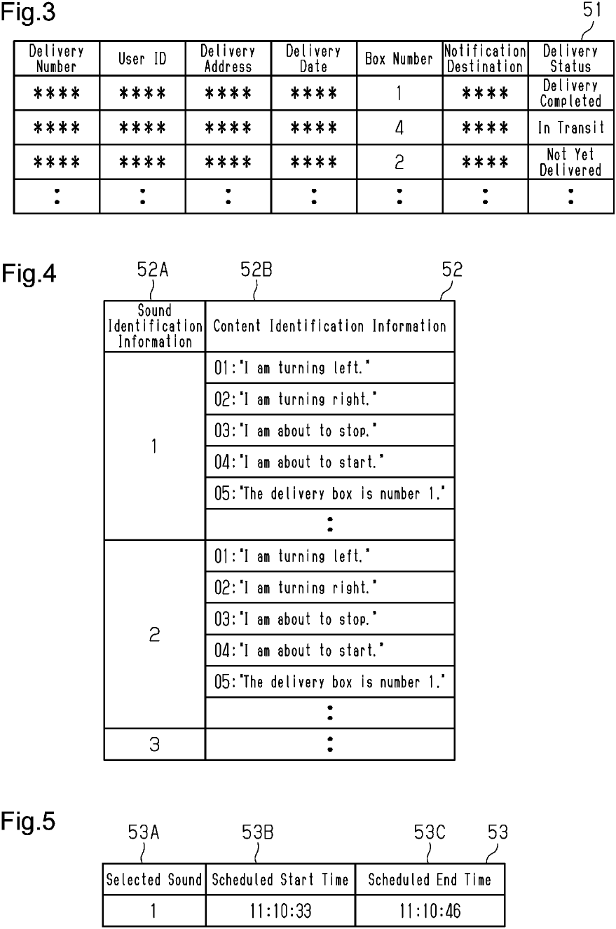

The data stored in the memory unit 12 of the server 10 and the memory unit 46 of the unmanned ground vehicle 30 will now be described with reference to FIGS. 3 to 5.

FIG. 3 shows an example of the data configuration of delivery plan information 51. The delivery plan information 51 is created for each unmanned ground vehicle 30 that delivers a package. The server 10 stores, in the memory unit 12, the delivery plan information 51 corresponding to the unmanned ground vehicles 30 each delivering a package. The unmanned ground vehicle 30 stores its delivery plan information 51 in the memory unit 46.

The delivery plan information 51 of FIG. 3 is data that indicates the delivery plan of one unmanned ground vehicle 30. The delivery plan information 51 includes a delivery number, a user ID, a delivery address, a delivery date, a box number, a notification destination, and a delivery status. The delivery number is identification information allocated to a package that is to be delivered. The user ID and delivery address each indicate a user who receives a package or the address of the user. The delivery address may be position information related to an area common to multiple users as a package delivery place. The delivery date indicates the date and time period in which a package is scheduled to be delivered. The box number indicates the identification information of a box 31 of the unmanned ground vehicle 30. That is, the box 31 is associated with a package corresponding to the delivery number. The notification destination is a destination selected when a notification is sent to the user. For example, a notification is sent on at least one of the following points in time: when the server 10 accepts a delivery request; when the unmanned ground vehicle 30 leaves a station; in a period during which the unmanned ground vehicle 30 departs the station and then reaches the delivery location; and when the unmanned ground vehicle 30 reaches the delivery location. The notification is sent from the unmanned ground vehicle 30 or the server 10 to the user device 20. The notification destination is, for example, the email address of the user, the telephone number of the user, or a device token of the user device 20. The notification destination may also include a sending destination to a communication device (e.g., an intercom). The delivery status indicates the delivery status of a package. For example, the delivery status is one of statuses including “delivery completed,” “in transit,” and “not yet delivered.” The delivery plan information 51 may include a delivery sequence and a delivery route.

FIG. 4 shows sound attribute information 52. The unmanned ground vehicle 30 stores, in the memory unit 46 as sound data, the sound attribute information 52 and waveform data (not shown) associated therewith.

The sound attribute information 52 includes sound identification information 52A and content identification information 52B. The sound identification information 52A is identification information assigned to a sound characteristic. For example, if there are three types of sounds each having a different characteristic, the sound identification information 52A may be any one of 1 to 3. The content identification information 52B is used to identify the content of a sound. The content of a sound includes, for example, a message given as guidance during traveling or operation guidance for a user to receive a package. Examples of the message include “I am turning left,” “I am turning right,” “I am about to stop,” “I am about to start,” and “The number of the delivery box is 1.” Multiple types of content identification information 52B are associated with one type of sound identification information 52A. Further, the waveform data corresponding to the sound identification information 52A is associated with the content identification information 52B. Multiple types of waveform data associated with the same sound identification information 52A each have the same sound characteristic. The sound output control unit 48 outputs a sound using the waveform data associated with the sound output event that has occurred. The sound data may also be stored in the memory unit 46 of the server 10.

FIG. 5 shows an example of the data configuration of sound selection information 53. The sound selection information 53 is stored in the memory unit 46 of the unmanned ground vehicle 30. The sound selection information 53 is data including the sound identification information 52A selected by the control unit 45. The sound selection information 53 includes a selected sound 53A, a scheduled start time 53B, and a scheduled end time 53C. When the control unit 45 selects no sound, the selected sound 53A records no sound identification information 52A. When the control unit 45 selects a sound, the selected sound 53A records the sound identification information 52A. The scheduled start time 53B indicates the time at which a sound starts to be output. The scheduled end time 53C indicates the time at which the outputting of a series of sounds is finished.

The scheduled start time 53B and the scheduled end time 53C are set in accordance with the content of a sound. For example, when the unmanned ground vehicle 30 performs an operation guidance, the scheduled end time 53C is a time at which the operation guidance using a sound is finished. For example, a series of sounds are output as the operation guidance for one user. The sounds include “Please enter a PIN code,” “Box number 1 will open,” “Please close the door,” and “I am about to start.” The point in time when the first sound (e.g., “Please enter a PIN code.”) starts to be output is the scheduled start time 53B. The point in time when the outputting of the final sound (e.g., “I will start.”) is finished is the scheduled end time 53C. When the series of sounds are output as one operation guidance in this manner, the characteristics of the sounds remains unchanged during the operation guidance. In a case in which the unmanned ground vehicle 30 alerts a person located nearby to the traveling of the unmanned ground vehicle 30 (e.g., a message saying “I am turning left.”), the time at which the unmanned ground vehicle 30 is estimated to start turning left may be a scheduled start time. Further, the time at which the unmanned ground vehicle 30 finishes turning left may be a scheduled end time. Additionally, the unmanned ground vehicle 30 may extend the scheduled end time depending on the situation of traveling.

The processes executed by the controller 32 will now be described. The controller 32 executes an acquisition process, a sound selection process, an output control process, and a cancellation process.

The control unit 45 of one unmanned ground vehicle 30 executes the acquisition process. The acquisition process is a process that acquires sound identification information 52A selected by another unmanned vehicle 30 located nearby. The sound identification information 52A is included in multiple types of sound identification information 52A each associated with a sound that has a different characteristic.

The control unit 45 executes the sound selection process. The sound selection process refers to the acquired sound identification information 52A to select sound identification information that is different from the sound identification information selected by another unmanned ground vehicle 30.

In the sound selection process, the control unit 45 determines whether the multiple types of sound identification information 52A include sound identification information 52A that has not been selected by another unmanned vehicle 30. When determining that the sound identification information 52A that has not been selected by the other unmanned vehicle 30 is present, the control unit 45 selects the sound identification information 52A that has not been selected by the other unmanned vehicle 30. When determining that the sound identification information 52A that has not been selected by the other unmanned vehicle 30 is not present, the control unit 45 specifies one of other unmanned ground vehicles 30 based on a predetermined condition as an exception. Then, the control unit 45 selects, as its sound identification information 52A, the sound identification information 52A selected by the specified unmanned ground vehicle 30.

The control unit 45 executes the output control process. Specifically, the control unit 45 outputs the selected sound identification information 52A and a sound output request to the sound output control unit 48. The sound output control unit 48 executes the output control process based on the sound output request. The output control process is a process that outputs a sound having a characteristic that corresponds to the selected sound identification information 52A.

### Operation

A procedure for the controller 32 of the unmanned ground vehicle 30 to select a sound will now be described.

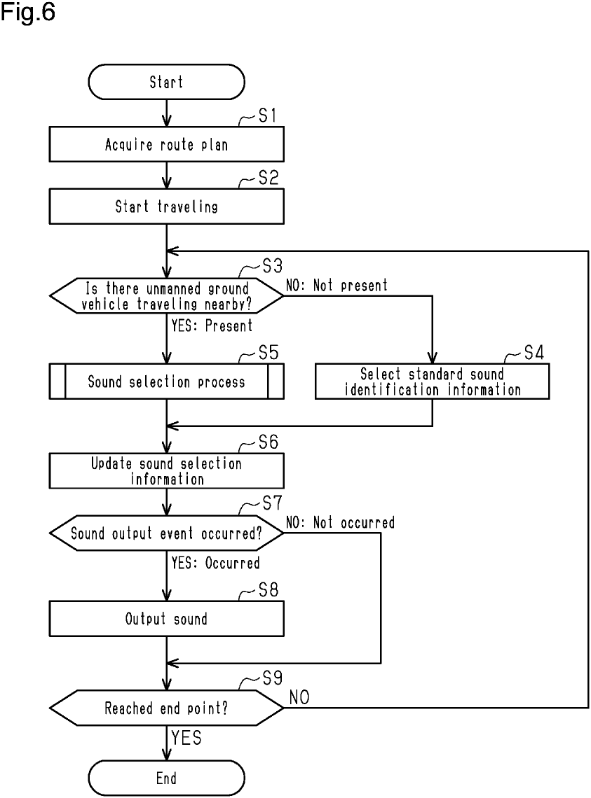

FIG. 6 shows a procedure of processes that output a sound.

First, the control unit 45 of one unmanned ground vehicle 30 starts delivering a package and then acquires a route plan (step S1). The route plan is created based on the delivery plan information 51 by the server 10 or the unmanned ground vehicle 30. The route plan indicates a route from a travel start point to a travel end point via a package delivery place. The route plan information indicating the route plan includes identification information related to a road or an intersection. The start point and the end point are stations (e.g., warehouses or stores). The start point may be the same as or different from the end point.

Based on the route plan, the control unit 45 drives the driving system 33 to start traveling (step S2). When the unmanned ground vehicle 30 leaves the start point, the control unit 45 executes vehicle-to-vehicle communication with another unmanned ground vehicle 30 located nearby via the communication unit 47. The control unit 45 sends its identification information and the sound selection information 53 to the other unmanned ground vehicle 30 as the data sent through the vehicle-to-vehicle communication. Further, the control unit 45 receives the sound selection information 53 that has been sent by the other unmanned ground vehicle 30. The control unit 45 may send the sound selection information 53 through broadcast communication to a nearby device capable of communicating with the control unit 45. Alternatively, the control unit 45 may send the sound selection information 53 only when determining that another unmanned ground vehicle 30 is located nearby or receiving a request from the other unmanned ground vehicle 30.

The control unit 45 executes vehicle-to-vehicle communication to determine whether another unmanned ground vehicle 30 is traveling nearby (step S3). For example, the control unit 45 determines whether another unmanned ground vehicle 30 is traveling nearby by determining whether the vehicle-to-vehicle communication data including the vehicle identification data of the unmanned ground vehicle 30 is received.

When determining that no unmanned ground vehicle 30 is traveling nearby (step S3: NO), the control unit 45 selects a standard type of the sound identification information 52A (step S4). The sound associated with the standard sound identification information 52A is heard most frequently by a user as a sound output from an unmanned ground vehicle 30. Alternatively, the sound associated with the standard sound identification information 52A is easiest to hear for a person located near an unmanned ground vehicle 30. The sound identification information 52A selected in step S4 may be the sound identification information 52A having the highest priority among the priorities each allocated to a corresponding type of the sound identification information 52A.

When determining that another unmanned ground vehicle 30 is traveling nearby (step S3: YES), the control unit 45 executes the sound selection process (step S5). In the sound selection process, the control unit 45 selects its sound identification information 52A such that the sound identification information 52A is not the same as sound identification information 52A selected by the other unmanned ground vehicle 30.

When terminating the sound selection process (step S5) or selecting the standard sound identification information 52A (step S4), the control unit 45 updates its sound selection information 53 (step S6). The control unit 45 records the selected sound identification information 52A in the sound selection information 53 as the selected sound 53A.

The control unit 45 determines whether a sound output event has occurred (step S7). The sound output event is an event (condition) that causes the unmanned ground vehicle 30 to output a sound to its surroundings. Multiple sound output events are set. An example of the sound output event is a risky situation that occurs near the unmanned ground vehicle 30. Another example of the sound output event is an event related to a traveling state of the unmanned ground vehicle 30 (e.g., turn, stop, or start). A further example of the sound output event is a situation in which a user who receives a package is supported. The support for receiving a package is necessary when, for example, the user starts operating the unmanned ground vehicle 30 or an emergency (e.g., the user forgot to take a package) occurs.

When determining that no sound output event has occurred (step S7: NO), the control unit 45 proceeds to step S9. When determining that a sound output event has occurred (step S7: YES), the control unit 45 outputs a sound (step S8). Specifically, the control unit 45 selects the content identification information 52B corresponding to the sound output event and sends, to the sound output control unit 48, the sound output request and the sound identification information 52A recorded in the selected sound 53A. Based on the sound identification information 52A and the content identification information 52B, the sound output control unit 48 outputs a sound having a characteristic that corresponds to the sound identification information 52A.

When determining that a sound output event has occurred, the control unit 45 determines a scheduled start time 53B and a scheduled end time 53C that correspond to the sound output event immediately before or at the same time as outputting a sound. The control unit 45 stores these times in the sound selection information 53.

For example, a sound output time may be determined in advance in accordance with a sound output event. Then, the control unit 45 may determine the scheduled start time 53B and the scheduled end time 53C based on the sound output time. When the sound output event is detection of a risky situation, a sound is output immediately after the detection of the sound output event. Thus, the scheduled start time 53B records the time at which the sound output event was detected. Alternatively, the scheduled start time 53B and the scheduled end time 53C may be determined based on the type of an object or the number of objects detected by the object detection sensor 40. When determining that multiple persons are located nearby, the control unit 45 may lengthen the period of outputting a sound than when one person is located nearby, and may specify the scheduled end time 53C based on that period.

Additionally, the sound output time may be determined in advance depending on the type of a traveling state (e.g., turn, stop, or start). Then, the control unit 45 may determine the scheduled start time 53B and the scheduled end time 53C based on the sound output time. Alternatively, the control unit 45 may determine the scheduled start time 53B and the scheduled end time 53C based on a vehicle traveling state. Examples of the vehicle traveling state include a detection result acquired from the position detection sensor 42 or the vehicle speed sensor 43, a steering angle acquired from the driving system 33, or a brake driving state acquired from the braking system 35. For example, the control unit 45 may calculate the time to turn at an intersection based on map data from which the vehicle speed, the steering angle, and the size of the intersection can be determined. Then, the control unit 45 may determine the scheduled start time 53B and the scheduled end time 53C based on the calculated time.

As another option, a sound output time may be determined in advance depending on the situation in which the receiving of a package needs to be supported. Then, the control unit 45 may use this sound output time to determine the scheduled start time 53B and the scheduled end time 53C.

When determining that no sound output event has occurred (step S7: NO) or outputting a sound (step S8), the control unit 45 determines whether the unmanned ground vehicle 30 has reached the end point (step S9). When determining that the unmanned ground vehicle 30 has not reached the end point (step S9: NO), the control unit 45 returns to step S3.

When determining that the unmanned ground vehicle 30 has reached the end point (step S9: YES), the control unit 45 terminates the sound output process. Further, the control unit 45 deselects the sound identification information 52A.

### Sound Selection Process

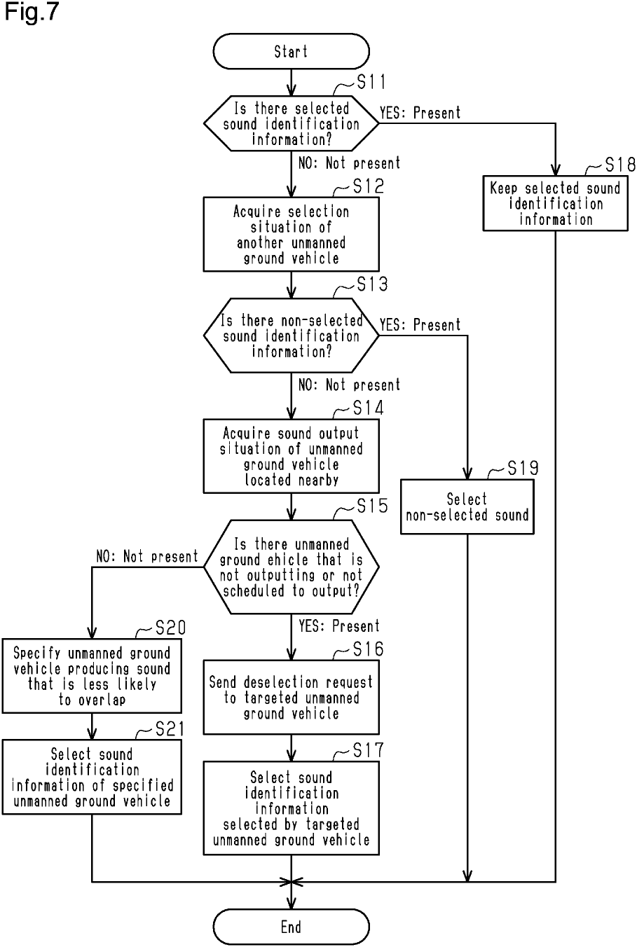

The sound selection process (step S5) will now be described in detail with reference to FIG. 7. The sound selection process is a process that generally selects sound identification information 52A that has not been selected by nearby unmanned ground vehicles 30. When the sound identification information 52A that has not been selected by the nearby unmanned ground vehicles 30 is not present, the control unit 45 specifies one of the nearby unmanned ground vehicle 30 based on a predetermined condition, and selects the sound identification information 52A selected by the specified unmanned ground vehicle 30.

First, the control unit 45 refers to the sound selection information 53 recorded in the memory unit 46 to determine whether the sound identification information 52A selected by the control unit 45 is present (step S11). When the selected sound identification information 52A is present (step S11: YES), the control unit 45 keeps the selected sound identification information 52A (step S18). In a case in which an operation guidance sound has already been output, the sound identification information 52A is kept selected at least until the operation guidance ends. That is, the characteristic of the sound remains unchanged during the operation guidance. Thus, a user does not feel confused.

When determining that the selected sound identification information 52A is not present (step S11: NO), the control unit 45 of the unmanned ground vehicle 30 (subject vehicle) acquires a selection situation of the sound identification information 52A of another unmanned ground vehicle 30 (step S12). The control unit 45 stores, in the memory unit 46, the communication data sent by another nearby unmanned ground vehicle 30. The control unit 45 acquires the sound selection information 53 of the data stored in the memory unit 46. Based on the vehicle position stored with the sound selection information 53, the control unit 45 may extract the sound selection information 53 of a vehicle located within a predetermined range from the subject vehicle. The predetermined range is a range in which a person readily hears a sound output from each unmanned ground vehicle 30. For example, in a case in which the sound output from the unmanned ground vehicle 30 can be heard when the person is located in a distance of less than or equal to 100 meters from the unmanned ground vehicle 30 and the sound is relatively difficult to hear when the person is located in a distance of greater than 100 meters from the unmanned ground vehicle 30, the predetermined range is a range of less than or equal to 100 meters. Alternatively, the control unit 45 may use, as communication data used to determine a selection situation of the sound identification information 52A, communication data received from all of other unmanned ground vehicles 30 capable of communicating with the subject vehicle.

The control unit 45 determines whether non-selected sound identification information 52A is present (step S13). Specifically, the control unit 45 refers to the acquired sound selection information 53 to determine whether the sound identification information 52A of 1 to 3 includes non-selected sound identification information 52A. For example, when only one unmanned ground vehicle 30 is located nearby and selects the sound identification information 52A of 1, the control unit 45 determines that the sound identification information 52A of 2 and the sound identification information 52A of 3 have not been selected. Further, when three other unmanned ground vehicles 30 are located nearby and respectively select the sound identification information 52A of 1 to 3, the control unit 45 determines that all the types of sound identification information 52A have been selected.

When determining that non-selected sound identification information 52A is present (i.e., selectable sound identification information 52A is present) (step S13: YES), the control unit 45 selects that non-selected sound identification information 52A (step S19) and terminates the sound selection process.

When determining that non-selected sound identification information 52A is not present (i.e., all the types of sound identification information 52A have been selected) (step S13: NO), the control unit 45 selects a sound output situation of the unmanned ground vehicle 30 located nearby (step S14). The sound output situation includes whether a sound is being output and whether a sound is scheduled to be output when the sound is not being output. Whether a sound is being output can be determined from whether the current time is included in a period from the scheduled start time 53B to the scheduled end time 53C that are included in the acquired sound selection information 53. Whether a sound is scheduled to be output can be determined from whether the scheduled start time 53B is included in sound selection information 53 that has been acquired in advance.

Further, the control unit 45 refers to the acquired sound output situation to determine whether there is an unmanned ground vehicle 30 that is not outputting a sound or an unmanned ground vehicle 30 that is not scheduled to output a sound (step S15). When determining that an unmanned ground vehicle 30 is outputting a sound or is scheduled to output a sound is not present (step S15: NO), the control unit 45 specifies one unmanned ground vehicle 30 that would produce a sound that is less likely to overlap other sounds in accordance with the predetermined condition (step S20). The control unit 45 acquires the movement direction and vehicle position from another unmanned ground vehicle 30 based on the communication data stored in the memory unit 46 or communication data that is newly acquired. For example, another unmanned ground vehicle 30 selected in the predetermined condition is a vehicle moving away from the subject vehicle and having the longest relative distance from the subject vehicle. When there is one unmanned ground vehicle 30 moving away from the subject vehicle, that unmanned ground vehicle 30 is specified. The direction in which a vehicle moves away from the subject vehicle is, for example, the same as the movement direction of the subject vehicle or a direction which is orthogonal to the movement direction of the subject vehicle and in which the vehicle does not approach the subject vehicle. If another unmanned ground vehicle 30 moves in a direction opposite of the movement direction of the subject vehicle, the other unmanned ground vehicle 30 would approach the subject vehicle. Thus, with the vehicle position of the other unmanned ground vehicle 30 taken into account, the direction opposite of the movement direction of the subject vehicle is excluded.

Further, the control unit 45 selects the sound identification information 52A that has been selected by the specified unmanned ground vehicle 30 (step S21). In this manner, the control unit 45 selects the sound identification information 52A of another unmanned ground vehicle 30 that produces a sound that is less likely to overlap other sounds. This limits situations in which sounds each having the same characteristic are produced at a position relatively close to the subject vehicle.

When determining that there is another unmanned ground vehicle 30 that is not outputting a sound or is not scheduled to output a sound (step S15: YES), the control unit 45 sends a deselection request to the other unmanned ground vehicle 30, which is a target of the deselection request (step S16). The deselection request is a request for deselecting the sound identification information 52A. The deselection request includes identification information of another unmanned ground vehicle 30 that is a target of the deselection request. Instead of the deselection request, a reselection request for selecting new sound identification information 52A again may be sent. The other unmanned ground vehicle 30 that has received the deselection request deselects its sound identification information 52A. The other unmanned ground vehicle 30 that has received the reselection process reselects sound identification information 52A. Then, the other unmanned ground vehicle 30 sends, to the unmanned ground vehicle 30 that has sent the deselection request, the information indicating that the cancellation is completed.

When receiving the information indicating that the cancellation is completed, the control unit 45 selects the sound identification information 52A that has been selected by the targeted unmanned ground vehicle 30 (step S17). Then, the control unit 45 terminates the sound selection process.

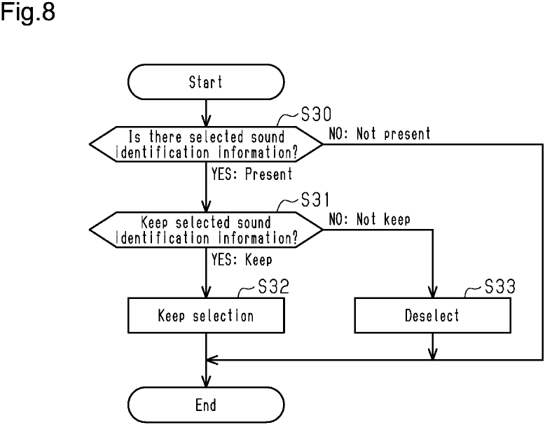

A deselection process will now be described with reference to FIG. 8. The control unit 45 executes the deselection process in parallel to the sound selection process or after terminating the sound selection process. The control unit 45 determines whether there is selected sound identification information 52A (step S30).

When determining that no sound identification information has been selected (step S30: NO), the control unit 45 terminates the deselection process (step S33). When determining that there is selected sound identification information (step S30: YES), the control unit 45 determines whether to keep the selected sound identification information 52A (step S31).

The control unit 45 determines whether to keep the sound identification information 52A, based on the scheduled end time 53C included in the sound selection information 53. In a case in which the current time has not reached the scheduled end time 53C, the control unit 45 determines to keep the sound identification information 52A. In a case in which the current time has reached the scheduled end time 53C, the control unit 45 determines to cancel the sound identification information 52A, instead of keeping it. When receiving the deselection request from another unmanned ground vehicle 30, the control unit 45 determines to cancel the sound identification information 52A, instead of keeping it.

When determining not to maintain the selected sound identification information 52A (step S31: NO), the control unit 45 deselects the sound identification information 52A (step S33). When determining to keep the selected sound identification information 52A (step S31: YES), the control unit 45 keeps the sound identification information 52A, instead of deselecting it (step S32).

In this manner, one unmanned ground vehicle 30 repeatedly selects and deselects the sound identification information 52A from the time when the one unmanned ground vehicle 30 leaves the start point. Thus, multiple unmanned ground vehicles 30 can use the sound identification information 52A effectively, although the types of sounds that can be selected by the unmanned ground vehicles 30 are limited. This limits situations in which different unmanned ground vehicles 30 each simultaneously output a sound having the same characteristic in a relatively close distance. Thus, a person located nearby readily identifies the unmanned ground vehicle 30 that outputs a sound to that person.

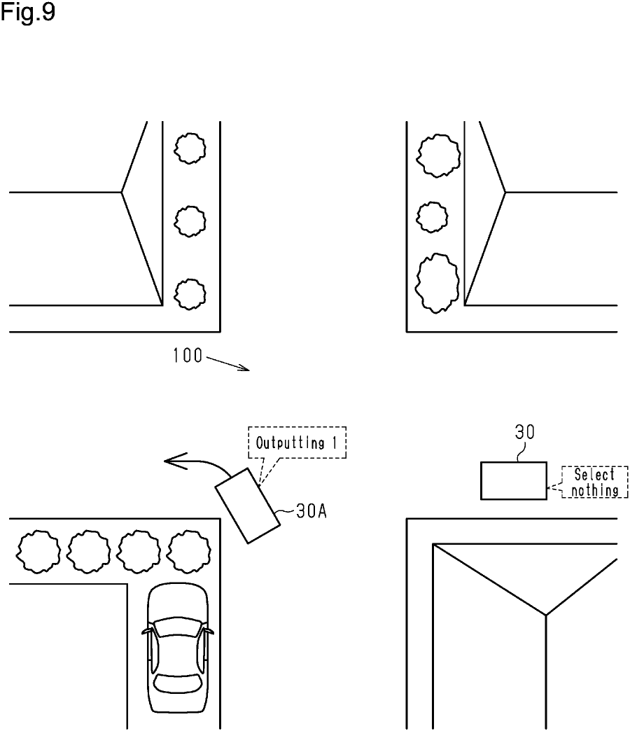

The sound selection process will now be described with reference to FIGS. 9 to 11. In this example, one unmanned ground vehicle 30 selects a sound while traveling nearby an intersection.

In the example of FIG. 9, one unmanned ground vehicle 30, which is the subject vehicle, is traveling ahead of an intersection 100. At the position shown in FIG. 9, the unmanned ground vehicle 30 does not select the sound identification information 52A. In addition to this unmanned ground vehicle 30, another unmanned ground vehicle 30A is located near the intersection 100. The other unmanned ground vehicle 30A is outputting a sound associated with the sound identification information 52A of 1. The other unmanned ground vehicle 30A outputs a sound saying “I am turning left.” while turning left at the intersection 100. The control unit 45 of the unmanned ground vehicle 30 executes vehicle-to-vehicle communication to acquire the sound identification information 52A selected by the other unmanned ground vehicle 30A. The control unit 45 of the unmanned ground vehicle 30 determines that the unmanned ground vehicle 30 can use the sound identification information 52A of 2 and that of 3 and selects one of them. The control unit 45 may select the sound identification information 52A based on the priority associated with each type of sound identification information 52A.

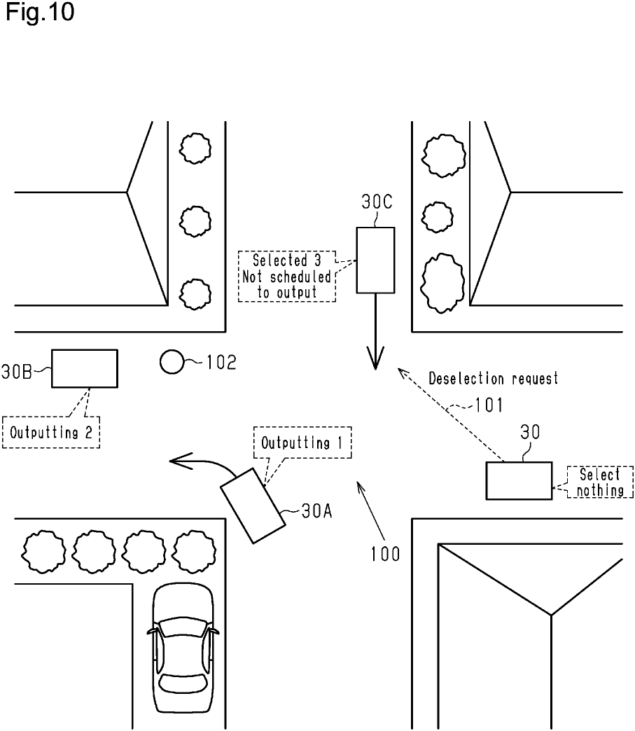

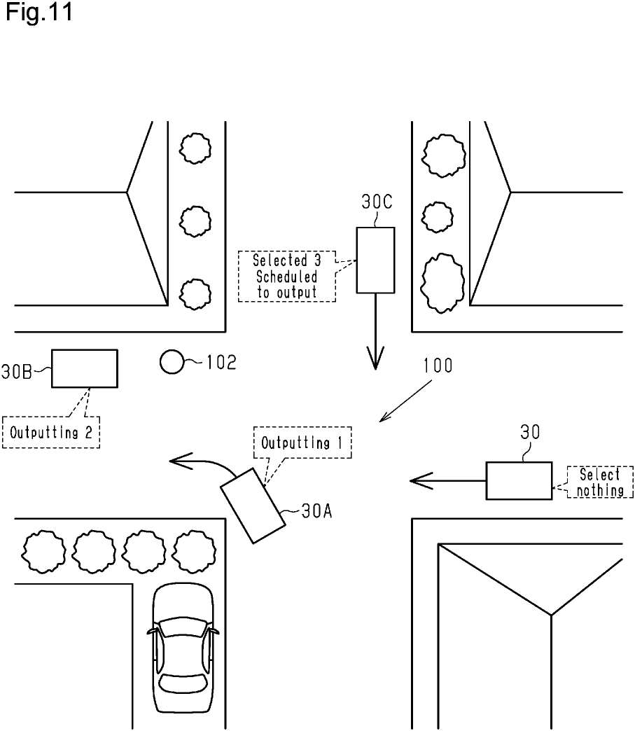

In the example of FIG. 10, other multiple (e.g., three) unmanned ground vehicles 30A to 30C are located near the intersection 100 in addition to the unmanned ground vehicle 30. The other unmanned ground vehicle 30A is outputting a sound associated with the sound identification information 52A of 1. The other unmanned ground vehicle 30B is outputting a sound associated with the sound identification information 52A of 2. The other unmanned ground vehicle 30B is outputting an operation guidance sound saying “Please enter a PIN code.” to a user 102 located nearby. The other unmanned ground vehicle 30C has selected a sound associated with the sound identification information 52A of 3, but is not scheduled to output it. In this situation, since all the types of sound identification information 52A have been selected, non-selected sound identification information 52A is not present. When the other unmanned ground vehicle 30C deselects the sound identification information 52A of 3, the unmanned ground vehicle 30 selects the sound identification information 52A of 3. In this case, the unmanned ground vehicle 30 and the other unmanned ground vehicle 30C may alternately select the sound identification information 52A of 3 until a sound output event occurs in one of them. However, the unmanned ground vehicle 30 takes the selection state of another unmanned ground vehicle 30 located nearby into account. Thus, when the relative distance between the unmanned ground vehicle 30 and the other unmanned ground vehicle 30C becomes greater, the unmanned ground vehicle 30 will be unaffected by the selection state of the other unmanned ground vehicle 30C. Alternatively, when the other unmanned ground vehicle 30A becomes farther from the intersection 100 so that the sound identification information 52A of 1 is not selected near the intersection 100, for example, the other unmanned ground vehicle 30A selects the sound identification information 52A of 1. Then, the other unmanned ground vehicle 30 becomes able to select the sound identification information 52A of 3.

In the example of FIG. 11, other multiple (e.g., three) unmanned ground vehicles 30A to 30C are located near the intersection 100 in addition to the unmanned ground vehicle 30. The other unmanned ground vehicles 30A, 30B are respectively outputting sounds associated with the sound identification information 52A of 1 and that of 2. The other unmanned ground vehicle 30C has selected a sound associated with the sound identification information 52A of 3, and is scheduled to output it. That is, the other unmanned ground vehicles 30A to 30C are each outputting a sound or scheduled to output a sound. In this case, from other unmanned ground vehicles 30 moving away from the subject vehicle, the control unit 45 selects the other unmanned ground vehicle 30 having the longest relative distance from the subject vehicle. In the example of FIG. 11, the unmanned ground vehicle 30 moving away from the subject vehicle is only the unmanned ground vehicle 30A. Thus, the control unit 45 selects the sound identification information 52A of 1. In this configuration, even if the unmanned ground vehicle 30 and the other unmanned ground vehicle 30A that have selected the same sound identification information 52A simultaneously output a sound having the same characteristic, the outputting of sounds at positions relatively close to each other is limited. This allows a person (e.g., the user 102 in FIG. 11) located near the intersection 100 to readily identify the unmanned ground vehicle 30 or 30A that outputs a sound to that person. The unmanned ground vehicle 30 serving as the subject vehicle corresponds to an example of a first unmanned ground vehicle. The other unmanned ground vehicle 30A to 30C correspond to an example of one or more second unmanned ground vehicles.

The advantages of the above embodiment will now be described.

(1) One unmanned ground vehicle 30 acquires the sound identification information 52A selected by another unmanned ground vehicle 30 located nearby and selects sound identification information 52A that is different from the sound identification information 52A. In this configuration, even if multiple approaching unmanned ground vehicles 30 located relatively close to each other output sounds in the same period, the characteristics of these sounds are different from each other. This allows a user located near the unmanned ground vehicles 30 to identify the unmanned ground vehicle 30 that outputs a sound to that user.

(2) One unmanned ground vehicle 30 selects sound identification information 52A that has not been selected by another unmanned ground vehicle 30 when the other unmanned ground vehicle 30 is located nearby. However, there may be a state in which the sound identification information 52A that has not been selected by the other unmanned vehicle 30 is not present (i.e., all the types of sound identification information 52A have been selected). In the above embodiment, when the sound identification information 52A that has not been selected by another unmanned ground vehicle 30 is present, the unmanned ground vehicle 30 selects that sound identification information 52A. Further, when the sound identification information 52A that has not been selected by other unmanned ground vehicles 30 is not present, one of the other unmanned ground vehicles 30 is specified based on the predetermined condition, and the sound identification information 52A selected by the specified unmanned ground vehicle 30 is selected. Thus, a person located nearby can select a sound allowing him to readily identify the unmanned ground vehicle 30 that outputs a sound to that person.

(3) In a state in which all the types of sound identification information 52A are selected, one unmanned ground vehicle 30 selects the sound identification information 52A that has been selected by another unmanned ground vehicle 30 that is not outputting a sound or another unmanned ground vehicle 30 that is not scheduled to output a sound. Thus, even if different unmanned ground vehicles 30 each output a sound having the same characteristic, these sounds are prevented from being output simultaneously.

(4) In a state in which all the types of sound identification information 52A are selected, one unmanned ground vehicle 30 sends the deselection request to other unmanned ground vehicles 30 located nearby. This allows the sound identification information 52A to be selected efficiently.

(5) In a state in which all the types of sound identification information 52A are selected, one unmanned ground vehicle 30 (subject vehicle) specifies one of other nearby unmanned ground vehicles 30 that is moving away from the subject vehicle and has the longest distance from the subject vehicle. Then, the unmanned ground vehicle 30 selects the sound identification information 52A selected by the specified other unmanned ground vehicle 30. In this configuration, these unmanned ground vehicles 30 do not continue to output a sound having the same characteristic at positions relatively close to each other. This allows a person located near the unmanned ground vehicles 30 to readily identify the unmanned ground vehicle 30 that outputs a sound to that person even if different unmanned ground vehicles 30 each output a sound having the same characteristic.

(6) One unmanned ground vehicle 30 deselects a selected sound when receiving a deselection request from another unmanned ground vehicle 30. This allows the sound identification information 52A to be selected efficiently between multiple unmanned ground vehicles 30.

(7) One unmanned ground vehicle 30 selects standard sound identification information 52A when no other unmanned ground vehicles 30 are located nearby. Thus, the sound identification information 52A is selected with a higher priority based on how easily a sound is heard and how familiar the user is with that sound.

(8) Multiple types of waveform data, each having different content, are associated with one type of the sound identification information 52A. The control unit 45 selects the waveform data corresponding to a sound output event. This allows one unmanned ground vehicle 30 to output a sound of which the characteristic does not overlap the characteristic of another unmanned ground vehicle 30 and which corresponds to the environment of the one unmanned ground vehicle 30.

(9) In the above embodiment, the sound identification information 52A is allocated to a virtual speaker that produces a sound. This allows a person located near unmanned ground vehicles 30 to identify the unmanned ground vehicle 30 that outputs a sound to him as he discerns the difference between the voices of persons.

(10) In the above embodiment, a sound is output using the same sound identification information 52A until the outputting of a series of sounds necessary for guiding a person located nearby is finished. This allows the person located nearby to hear the content of the series of sounds with the sound having the same characteristic.

The above embodiment may be modified as follows. The above embodiment and the following modifications can be combined as long as the combined modifications remain technically consistent with each other.

### Sound Selection Process

In the above embodiment, the sound identification information 52A is selected before a sound output event occurs. Instead, the sound identification information 52A may be selected when a sound output event occurs.

In the above embodiment, when the control unit 45 of one unmanned ground vehicle 30 determines that all the types of sound identification information 52A have been selected, the control unit 45 specifies one of other unmanned ground vehicles 30 based on the predetermined condition. Then, the unmanned ground vehicle 30 selects the sound identification information 52A selected by the specified other unmanned ground vehicle 30. Instead, when determining that all the types of sound identification information 52A have been selected, the unmanned ground vehicle 30 may wait until the other unmanned ground vehicle 30 finishes outputting a sound.

In the above embodiment, when the control unit 45 determines that all the types of sound identification information 52A have been selected, the control unit 45 specifies an unmanned ground vehicle 30 that is not outputting a sound or is not scheduled to output a sound. Then, the unmanned ground vehicle 30 selects the sound identification information 52A selected by the specified unmanned ground vehicle 30. Instead, the control unit 45 of one unmanned ground vehicle 30 may specify only an unmanned ground vehicle 30 that is not outputting a sound, without taking into account whether a sound is scheduled to be output. In this case, when an unmanned ground vehicle 30 that is not outputting a sound is not present, the control unit 45 may specify an unmanned ground vehicle 30 that produces a sound that is less likely to overlap other sounds. In this configuration, the unmanned ground vehicle 30 deselects the sound when determining that the outputting of a series of sounds is finished. In this case, the scheduled start time 53B and the scheduled end time 53C do not have to be recorded in the sound selection information 53.

In the above embodiment, when the control unit 45 of one unmanned ground vehicle 30 determines that all the types of sound identification information 52A have been selected and determines that there is an unmanned ground vehicle 30 that is not outputting a sound or is not scheduled to output a sound, the control unit 45 sends a deselection request to that unmanned ground vehicle 30. Instead, when determining that all the types of sound identification information 52A have been selected, the control unit 45 may specify another unmanned ground vehicle 30 on a condition other than a sound output situation, and send a deselection request to the specified other unmanned ground vehicle 30. The condition other than the sound output situation may be that the sound output event of the subject vehicle is more emergent or important than that of another vehicle. Alternatively, the control unit 45 may send deselection requests to all the other unmanned ground vehicles 30 located nearby, and each unmanned ground vehicle 30 that has received a corresponding deselection request may select whether to cancel the sound identification information 52A. The unmanned ground vehicle 30 that has selected cancelling the sound identification information 52A cancels the sound identification information 52A. Then, that unmanned ground vehicle 30 sends information indicating the cancellation and its identification information to the unmanned ground vehicle 30 that has sent the deselection request.

In the above embodiment, when the control unit 45 of one unmanned ground vehicle 30 (subject vehicle) determines that all the types of sound identification information 52A have been selected and determines that there is no other unmanned ground vehicle 30 that is not outputting a sound or is not scheduled to output a sound, the control unit 45 specifies one of the other unmanned ground vehicles 30 moving away from the subject vehicle. Then, the unmanned ground vehicle 30 selects the sound identification information 52A selected by the specified other unmanned ground vehicle 30. Instead of taking the movement direction into account, one of the other unmanned ground vehicles 30 that has the longest relative distance may be specified.

Instead of taking the relative distance into account, one of the other unmanned ground vehicles 30 that moves in a direction that is different from the movement direction of the subject vehicle may be specified. Then, the sound identification information 52A of the specified unmanned ground vehicle 30 may be selected.

In the above embodiment, when the control unit 45 determines that all the types of sound identification information 52A have been selected and determines that there is an unmanned ground vehicle 30 that is not outputting a sound or is not scheduled to output a sound, the control unit 45 specifies another unmanned ground vehicle 30 that produces a sound that is less likely to overlap other sounds. Then, the control unit 45 sends a deselection request to that unmanned ground vehicle 30. Instead of sending the deselection request, the control unit 45 may select the sound identification information 52A selected by that unmanned ground vehicle 30. In this case, the control unit 45 selects the sound identification information 52A of the unmanned ground vehicle 30 that is not outputting a sound or is not scheduled to output a sound. This minimizes situations in which sounds having the same characteristic are output simultaneously.

### Output Control Process

In the above embodiment, the sound identification information 52A is allocated to each virtual speaker that produces a sound. The unmanned ground vehicle 30 outputs the sound of a message saying “I am turning left” based on the selected sound identification information 52A. Instead of, or in addition to this configuration, the sounds associated with the sound identification information 52A may be sounds that do not include verbal messages. Such sounds are, for example, beep sounds or warning sounds each having a different characteristic (e.g., frequency or tempo).

### Unmanned Vehicle

Instead of, or in addition to delivering a package, the unmanned ground vehicle 30 may pick up a package.

The unmanned vehicle may be an unmanned aerial vehicle. The unmanned aerial vehicle is an aerial vehicle without a person onboard. In the same manner as the unmanned ground vehicle 30, the unmanned aerial vehicle includes a control device, a drive unit, a battery, and a HMI. The drive unit includes, for example, a drive source that is driven by electric power supplied from the battery and a rotary wing that is operated by power obtained from the drive source. In addition to a program for autonomous flying, the memory unit of the controller stores various types of information (e.g., map information and carrying plan information). When multiple unmanned aerial vehicles deliver packages in the same delivery area and approach each other, their alert sounds or their operation guidance sounds may overlap each other. Thus, if a process that outputs a sound in the same procedure as that of the above embodiment is executed, a person located nearby readily identifies the unmanned aerial vehicle that outputs a sound to that person.

Instead of traveling autonomously, one unmanned ground vehicle 30 may follow a leading vehicle (e.g., another unmanned ground vehicle 30). Unmanned ground vehicles 30 may be used for purposes other than delivery.

The unmanned ground vehicle 30 may be remotely operated by a manager terminal. The manager terminal is connected to the network 14. In this modification, one unmanned ground vehicle 30 selects the sound identification information 52A through vehicle-to-vehicle communication with another unmanned ground vehicle 30 located nearby.

### Configuration of Logistics Management System

Instead of the unmanned ground vehicle 30, the server 10 may include the sound memory unit 49. For example, when the selection of the sound identification information 52A is completed, the unmanned ground vehicle 30 sends, to the server 10, a request for sending sound data. When receiving the request for sending the sound data, the server 10 may send the sound data to the unmanned ground vehicle 30.

In the above embodiment, one unmanned ground vehicle 30 executes vehicle-to-vehicle communication to send and receive the sound selection information 53 or a deselection request to and from another unmanned ground vehicle 30. Instead, the unmanned ground vehicle 30 may execute road-to-vehicle communication to send and receive the sound selection information 53 or a deselection request to and from a roadside communication device. The communication device collects various types of data from unmanned ground vehicles 30 located nearby and sends the collected data to these unmanned ground vehicles 30. Alternatively, the unmanned ground vehicle 30 may send and receive the sound selection information 53 or a deselection request to and from the server 10. The server 10 collects various types of data from the unmanned ground vehicle 30. Further, the server 10 sends the data to an unmanned ground vehicle 30 of which the relative distance to the unmanned ground vehicle 30 that sends the data is less than a predetermined distance.

Instead of the unmanned ground vehicle 30, the server 10, a manager terminal, or another device connected to the network 14 may execute at least one of the acquisition process, the sound selection process, and the output control process. For example, in a case in which the server 10 executes some of the processes and the unmanned ground vehicle 30 executes the remaining processes, the server 10 and the unmanned ground vehicle 30 send and receive the results of the processes to and from each other if the results need to be shared. Further, the server 10 may include multiple devices. For example, the server 10 may include a PF server that provides a logistics management platform and a management server that generates an actual delivery plan based on the information acquired from the PF server.

### Supplementary Claims

The above embodiment includes the configurations described in the following aspects.

[Aspect 1] An unmanned vehicle that executes:
an acquisition process that acquires sound identification information selected by another unmanned vehicle located nearby, wherein the sound identification information is included in multiple types of sound identification information each associated with a sound that has a different characteristic;
a sound selection process that refers to the acquired sound identification information to select sound identification information that is different from the sound identification information selected by at least one of the other unmanned vehicle; and
an output control process that outputs a sound having a characteristic corresponding to the selected sound identification information.

[Aspect 2] The unmanned vehicle according to aspect 1, where
in the sound selection process, the unmanned vehicle may:
   determine whether the multiple types of sound identification information include sound identification information that has not been selected by the other unmanned vehicles; and
   when the sound identification information that has not been selected by the other unmanned vehicles is present, select the sound identification information that has not been selected by the other unmanned vehicles,
the other unmanned vehicle include other unmanned vehicles, and
in the sound selection process, the unmanned vehicle may:
   when determining that all the types of sound identification information have been selected by the other unmanned vehicles, specify one of the other unmanned vehicles based on a predetermined condition and select sound identification information selected by the specified one of the other unmanned vehicles.

[Aspect 3] The unmanned vehicle according to aspect 1 or 2, where
the other unmanned vehicle include other unmanned vehicles, and
in the sound selection process, the unmanned vehicle may determine whether the multiple types of sound identification information include sound identification information that has not been selected by the other unmanned vehicles and, when determining that all the types of sound identification information have been selected, select sound identification information selected by one of the other unmanned vehicles that is not outputting a sound.

[Aspect 4] The unmanned vehicle according to claim 3, where, in the sound selection process, the unmanned vehicle may select sound identification information selected by one of the other unmanned vehicles that is not scheduled to output a sound when determining that all the types of sound identification information have been selected and cannot specify the one of the other unmanned vehicles that is not outputting a sound.

[Aspect 5] The unmanned vehicle according to any one of aspects 1 to 4, where, in the sound selection process, when determining that all the types of sound identification information have been selected, the unmanned vehicle may request the other unmanned vehicles located nearby to deselect the types of sound identification information.

[Aspect 6] The unmanned vehicle according to any one of aspects 1 to 5, where the other unmanned vehicle include other unmanned vehicles, and

in the sound selection process, the unmanned vehicle may specify one of the other unmanned vehicles that is moving away from the unmanned vehicle and select sound identification information selected by the specified unmanned vehicle when determining that all the types of sound identification information have been selected.

[Aspect 7] The unmanned vehicle according to any one of aspects 1 to 6, where the other unmanned vehicle include other unmanned vehicles, and

in the sound selection process, the unmanned vehicle may specify one of the other unmanned vehicles that has the longest relative distance from the unmanned vehicle and select sound identification information selected by the specified unmanned vehicle when determining that all the types of sound identification information have been selected.

[Aspect 8] The unmanned vehicle according to any one of aspects 1 to 7, where, in the sound selection process, the unmanned vehicle may select a standard type of the sound identification information when the other unmanned vehicles are not located nearby.

[Aspect 9] The unmanned vehicle according to any one of aspects 1 to 8, wherein the unmanned vehicle may further execute a cancellation process that deselects the selected sound identification information when receiving a request for deselecting the sound identification information.

[Aspect 10] The unmanned vehicle according to any one of aspects 1 to 9, where
in the sound selection process, multiple types of output control data each having different content may be associated with one type of the sound identification information, and
the unmanned vehicle may select, from the selected sound identification information, one type of the output control data corresponding to a sound output event that causes a sound to be output.

[Aspect 11] The unmanned vehicle according to any one of aspects 1 to 10, where the sound identification information may be allocated to a virtual speaker that produces a sound.

[Aspect 12] The unmanned vehicle according to any one of aspects 1 to 11, where the unmanned vehicle may:
deliver a package to a delivery location; and
in the output control process, output a sound that supports an operation by a user to receive the package.

[Aspect 13] The unmanned vehicle according to any one of aspects 1 to 12, where, in the sound selection process, the unmanned vehicle may output a sound using the same sound identification information until the unmanned vehicle finishes outputting a series of sounds necessary for guiding a person located nearby.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

1. An unmanned vehicle configured to execute:
an acquisition process that acquires sound identification information selected by one or more other unmanned vehicles located nearby, wherein the sound identification information is included in multiple types of sound identification information each associated with a sound that has a different characteristic;
a sound selection process that refers to the acquired sound identification information to select sound identification information that is different from the sound identification information selected by at least one of the other unmanned vehicles; and
an output control process that outputs a sound having a characteristic corresponding to the selected sound identification information.

2. The unmanned vehicle according to claim 1, wherein
the one or more other unmanned vehicles include other unmanned vehicles, and
in the sound selection process, the unmanned vehicle is configured to:
determine whether the multiple types of sound identification information include sound identification information that has not been selected by the other unmanned vehicles;
when the sound identification information that has not been selected by the other unmanned vehicles is present, select the sound identification information that has not been selected by the other unmanned vehicles; and
when determining that all the types of sound identification information have been selected by the other unmanned vehicles, specify one of the other unmanned vehicles based on a predetermined condition and select sound identification information selected by the specified one of the other unmanned vehicles.

3. The unmanned vehicle according to claim 1, wherein, in the sound selection process, the unmanned vehicle is configured to determine whether the multiple types of sound identification information include sound identification information that has not been selected by the one or more other unmanned vehicles and, when determining that all the types of sound identification information have been selected, select sound identification information selected by one of the other unmanned vehicles that is not outputting a sound.

4. The unmanned vehicle according to claim 3, wherein, in the sound selection process, the unmanned vehicle is configured to select sound identification information selected by one of the other unmanned vehicles that is not scheduled to output a sound when determining that all the types of sound identification information have been selected and cannot specify the one of the other unmanned vehicles that is not outputting a sound.

5. The unmanned vehicle according to claim 1, wherein, in the sound selection process, when determining that all the types of sound identification information have been selected, the unmanned vehicle is configured to request the one or more of the other unmanned vehicles located nearby to deselect the types of sound identification information.

6. The unmanned vehicle according to claim 1, wherein
the one or more other unmanned vehicles include other unmanned vehicles, and
in the sound selection process, the unmanned vehicle is configured to specify one of the other unmanned vehicles that is moving away from the unmanned vehicle and select sound identification information selected by the specified unmanned vehicle when determining that all the types of sound identification information have been selected.

7. The unmanned vehicle according to claim 1, wherein
the one or more other unmanned vehicles include other unmanned vehicles, and
in the sound selection process, the unmanned vehicle is configured to specify one of the other unmanned vehicles that has the longest relative distance from the unmanned vehicle and select sound identification information selected by the specified unmanned vehicle when determining that all the types of sound identification information have been selected.

8. The unmanned vehicle according to claim 1, wherein, in the sound selection process, the unmanned vehicle is configured to select a standard type of the sound identification information when the other unmanned vehicles are not located nearby.

9. The unmanned vehicle according to claim 1, wherein the unmanned vehicle is further configured to execute a cancellation process that deselects the selected sound identification information when receiving a request for deselecting the sound identification information.

10. The unmanned vehicle according to claim 1, wherein
in the sound selection process, multiple types of output control data each having different content are associated with one type of the sound identification information, and
the unmanned vehicle is configured to select, from the selected sound identification information, one type of the output control data corresponding to a sound output event that causes a sound to be output.

11. The unmanned vehicle according to claim 1, wherein the sound identification information is allocated to a virtual speaker that produces a sound.

12. The unmanned vehicle according to claim 1, wherein
the unmanned vehicle is configured to:
deliver a package to a delivery location; and
in the output control process, output a sound that supports an operation by a user to receive the package.

13. The unmanned vehicle according to claim 1, wherein, in the sound selection process, the unmanned vehicle is configured to output a sound using the same sound identification information until the unmanned vehicle finishes outputting a series of sounds necessary for guiding a person located nearby.

14. An information process method executed by an unmanned vehicle or a controller that controls the unmanned vehicle, the information processing method comprising:
acquiring sound identification information selected by one or more other unmanned vehicles located nearby, wherein the sound identification information is included in multiple types of sound identification information each associated with a sound that has a different characteristic;
referring to the acquired sound identification information to select sound identification information that is different from the sound identification information selected by at least one of the other unmanned vehicles; and
outputting a sound having a characteristic corresponding to the selected sound identification information.

15. An information processing system comprising:
a server; and
unmanned vehicles, wherein
the unmanned vehicles include a first unmanned vehicle and one or more second unmanned vehicles,
at least one of the server or the first unmanned vehicle is configured to execute:
a process that acquires sound identification information selected by the one or more second unmanned vehicles located near the first unmanned vehicle, wherein the sound identification information is included in multiple types of sound identification information each associated with a sound that has a different characteristic;
a process that refers to the acquired sound identification information to select sound identification information that is different from the sound identification information selected by at least one of the second unmanned vehicles; and
a process that causes the first unmanned vehicle to output a sound having a characteristic corresponding to the selected sound identification information.
